(19) United States
(12) Patent Application Publication
(10) Pub. No.: US 2023/0382089 A1
(43) Pub. Date: Nov. 30, 2023

(54) MULTILAYER STRUCTURE, AND PACKAGE MATERIAL USING SAME

(71) Applicant: KURARAY CO., LTD., Okayama (JP)

(72) Inventors: Hiroyuki Shimo, Chiyoda-ku, Tokyo (JP); Masahiro Kitamura, Melsele (BE); Houssier Didier, Melsele (BE)

(73) Assignee: KURARAY CO., LTD., Okayama (JP)

(21) Appl. No.: 18/031,943

(22) PCT Filed: Oct. 14, 2021
(86) PCT No.: PCT/JP2021/038090

§ 371 Date: Apr. 14, 2023

(30) Foreign Application Priority Data
Oct. 15, 2020 (JP) 2020-173632

(51) Int. Cl. B32B 27/08; B32B 27/22; B32B 27/32; B65D 65/40

(52) U.S. Cl. CPC B32B 27/08; B32B 27/22; B32B 27/327; B65D 65/40; B32B 2250/03; B32B 2250/24; B32B 2329/04

(57) ABSTRACT

The present disclosure provides a multilayer film having a polyolefin layer (A), an adhesive resin layer (B), and an ethylene-vinyl alcohol copolymer resin composition layer (C).

### TECHNICAL FIELD

The present invention relates to a multilayer film, a food packaging material, a beverage packaging material, a medicine packaging material, a cosmetic packaging material, an agricultural material and a recovered composition, and a method for producing a recovered composition.

### BACKGROUND ART

A laminated film comprising a polyamide resin (hereinafter, sometimes referred to as “Nylon”) layer or an ethylene-vinyl alcohol copolymer (hereinafter, sometimes referred to as “EVOH”) layer, and a polyolefin resin layer has been conventionally used as a transparent packaging material with excellent mechanical strength and oxygen barrier (gas barrier) properties. Furthermore, there is known a laminated film in which Nylon layers are disposed on both sides of an EVOH layer and polyolefin resin layers are further disposed on the outer sides of the Nylon layers for improving strength of the laminated film (Patent Reference No. 1).

In recent years, demand for so-called post-consumer recycling (hereinafter, sometimes simply abbreviated as recycling) in which packaging materials consumed in the market are recovered and recycled, has been globally increased due to environmental problems and waste problems. Recycling is generally conducted by a process comprising cutting a recovered packaging material and, after, if necessary, sorting and washing, melt-mixing it using an extruder. A polyamide resin (Nylon) cannot be uniformly mixed with a polyolefin in a melt-mixing step of a recovery and recycling process due to a higher processing temperature and poor compatibility to a polyolefin, posing an impediment to recycling. For example, there is a problem that in a laminated film described in Patent Reference No. 1 during recovering and recycling, a to polyamide resin chemically reacts with EVOH to be crosslinked to form hard spots, leading to poor recyclability. It has been, therefore, needed to develop a laminated film free from a polyamide layer.

Patent Reference No. 2 has described, as a laminated film free from a polyamide layer, a multilayer structure comprising a hard layer having a puncture strength of 40 N/mm or more and 150 N/mm or less and a resin composition layer made of a particular EVOH, and has also described that such a multilayer structure is excellent in mechanical strength and thermal formability, and when being recovered, allows for melt forming with less hard spots due to resin deterioration (gelation).

### PRIOR ART REFERENCES

### Patent References

Patent Reference No. 1: JP 2001-79996 A

Patent Reference No. 2: WO 2020/071513 A1

### SUMMARY OF THE INVENTION

### Problems to be Solved by the Invention

However, there has been found that the multilayer structure described in Patent Reference No. 2 has a problem that during film forming, strong shear stress is applied between an adhesive resin layer and a resin composition layer made of a particular EVOH, to make a thickness of the resin composition layer uneven, leading to turbulence in a layer interface and thus deterioration in film appearance. The inventors have found for the first time that deterioration of film appearance is noticeable when a thickness ratio of the resin composition layer made of a particular EVOH to the multilayer structure is low. Furthermore, it has been found that when an additive is added for solving such a problem, a resin pressure of an extruder used for forming the resin composition layer made of a particular EVOH may be unstable depending on the type and the amount of the additive, possibly leading to poor quality stability of a product obtained.

To solve the above problems, an objective of the present invention is to provide a multilayer film, food packaging material, beverage packaging material, medicine packaging material, cosmetic packaging material and agricultural material, which are excellent in appearance, recyclability, bending resistance and quality stability. Another objective of the present invention is to provide a recovered composition with which formation of fisheyes can be suppressed when forming a film of a recovered composition containing a recovered material of the multilayer film of the present invention, and a production method therefor.

### Means for Solving the Problems

The above problems are solved by providing the followings:

[1] A multilayer film having a layer configuration in which a polyolefin layer (A) (hereinafter, sometimes abbreviated as “PO layer (A)”), an adhesive resin layer (B) and an ethylene-vinyl alcohol copolymer resin composition layer (C) (hereinafter, sometimes abbreviated as “EVOH resin composition layer (C)”) are laminated in this sequence, wherein the EVOH resin composition layer (C) comprises an ethylene-vinyl alcohol copolymer resin (c1) (hereinafter, sometimes abbreviated as “EVOH resin (c1)” with an ethylene-unit content of 20 mol % or more and 60 mol % or less and a saponification degree of 90 mol % or more, and a hydrophobic plasticizer (c2);

a content of the EVOH resin (c1) in the EVOH resin composition layer (C) is 60% by mass or more and 99.9% by mass or less;

an average ethylene-unit content of the EVOH resin (c1) constituting the EVOH resin composition layer (C) is 30 mol % or more and 60 mol % or less;

a content of the hydrophobic plasticizer (c2) in the EVOH resin composition layer (C) is 0.1% by mass or more and 3% by mass or less;

the EVOH resin composition layer (C) can further comprise a phosphoric acid compound (c3) and a content of the phosphoric acid compound (c3), when being comprised in the EVOH resin composition layer (C), is 500 ppm or less in terms of phosphoric acid radical;

the EVOH resin composition layer (C) is free from Nylon 6; and

a ratio of a thickness of the ethylene-vinyl alcohol copolymer resin composition layer (C) to the total thickness of the multilayer film is 7.5% or less;

[2] The multilayer film of [1], wherein the hydrophobic plasticizer (c2) comprised in the ethylene-vinyl alcohol copolymer resin composition layer (C) is an aliphatic ester;

[3] The multilayer film of [1] or [2], wherein a ratio of a thickness of the ethylene-vinyl alcohol copolymer resin composition layer (C) to the total thickness of the multilayer film is 5% or less; [4] The multilayer film of any of [1] to [3], wherein a content of the hydrophobic plasticizer (c2) in the ethylene-vinyl alcohol copolymer resin composition layer (C) is 0.6% by mass or more and 3% by mass or less;

[5] The multilayer film of any of [1] to [4], wherein the ethylene-vinyl alcohol copolymer resin composition layer (C) comprises a thermoplastic resin (c4) other than the EVOH resin (c1), and a mass ratio (c4/c1) of the thermoplastic resin (c4) to the EVOH resin (c1) in the ethylene-vinyl alcohol copolymer resin composition layer (C) is 10/90 to 40/60;

[6] The multilayer film of [5], wherein the thermoplastic resin (c4) comprises an acid-modified polyolefin; [7] The multilayer film of [5], wherein the thermoplastic resin (c4) comprises the ethylene-vinyl alcohol copolymer resin with an ethylene-unit content of more than 60 mol %;

[8] The multilayer film of [5], wherein the thermoplastic resin (c4) comprises at least one selected from the group consisting of Nylon 6/12, Nylon 6/66 and Nylon 6/66/12;

[9] The multilayer film of any of [1] to [8], wherein the polyolefin resin constituting the polyolefin layer (A) is at least one selected from the group consisting of a low density polyethylene, a medium density polyethylene, a high density polyethylene, a linear low density polyethylene and a polypropylene; The multilayer film of any of [1] to [9], wherein the polyolefin resin

constituting the polyolefin layer (A) is a metallocene polyolefin produced by polymerization using a metallocene catalyst;

A food packaging material, a beverage packaging material, a medicine packaging material, a cosmetic packaging material, or an agricultural material produced using the multilayer film of any of [1] to [10];

A recovered composition comprising a recovered material of the multilayer film of any of [1] to [10];

A method for producing a recovered composition, comprising melt kneading a recovered material of the multilayer film of any of [1] to [10].

### Effects of the Invention

According to the present invention, there can be provided a multilayer film which is excellent in appearance, recyclability, bending resistance and quality stability, as well as a packaging material such as a food packaging material, a beverage packaging material, a medicine packaging material and a cosmetic packaging material, and an agricultural material produced therewith. Furthermore, there can be provided a recovered composition with which formation of fisheyes can be suppressed when forming a film of a recovered composition containing a recovered material of the multilayer film of the present invention, and a production method therefor. Here, appearance, recyclability, bending resistance and quality stability herein can be evaluated as described in Examples as follows. “Appearance” can be evaluated by visually observing the presence of unevenness in a multilayer film as described in Examples. “Recyclability” can be evaluated by the number of fisheyes when forming a film of a recovered material of the multilayer film of the present invention as described in Examples. “Bending resistance” can be evaluated by the number of pinholes after a bending test as described in Examples. “Quality stability” can be evaluated by observing variation of a resin pressure of an extruder for an EVOH resin composition layer (C) as described in Examples.

### MODES FOR CARRYING OUT THE INVENTION

A multilayer film of the present invention is a multilayer film having a layer configuration in which a PO layer (A), an adhesive resin layer (B) and an EVOH resin composition layer (C) are laminated in this sequence, wherein the EVOH resin composition layer (C) comprises an EVOH resin (c1) with an ethylene-unit content of 20 mol % or more and 60 mol % or less and a saponification degree of mol % or more, and a hydrophobic plasticizer (c2); a content of the EVOH resin (c1) in the EVOH resin composition layer (C) is 60% by mass or more and 99.9% by mass or less; an average ethylene-unit content of the EVOH resin (c1) constituting the EVOH resin composition layer (C) is 30 mol % or more and mol % or less; a content of the hydrophobic plasticizer (c2) in the EVOH resin composition layer (C) is 0.1% by mass or more and 3% by mass or less; the EVOH resin composition layer (C) can further comprise a phosphoric acid compound (c3); when the EVOH resin composition layer (C) comprises the phosphoric acid compound (c3), its content is 500 ppm or less in terms of phosphoric acid radical, the EVOH resin composition layer (C) is free from Nylon 6; and a ratio of a thickness of the EVOH layer (C) to the total thickness of the multilayer film is 7.5% or less.

The term, “PO layer (A)” as used herein means a layer containing a polyolefin resin as a main component. A main component here means a component contained in more than 50% by mass in the layer. The term, “adhesive resin layer (B)” means a layer containing an adhesive resin. The expression, “an average ethylene-unit content of the EVOH resin (c1) constituting the EVOH resin composition (C) is 30 mol % or more and 60 mol % or less” means that when the EVOH resin (c1) constituting the EVOH resin composition (C) is used alone, an ethylene-unit content of the EVOH resin (c1) is 30 mol % or more and 60 mol % or less while when the EVOH resin (c1) is used as a mixture of two or more, an average calculated from a mixed mass ratio is 30 mol % or more and 60 mol % or less. For example, when an EVOH resin composition (C) contains, as an EVOH resin (c1), 80 parts by mass of an EVOH resin with an ethylene-unit content of 27 mol % and 20 parts by mass of an EVOH resin with an ethylene-unit content of 44 mol %, an average ethylene-unit content of the EVOH resin (c1) is 30.4 mol %. The term, “film” as used herein means a layer substance with a thickness of less than 400 μm. A “total thickness of a multilayer film” means the sum of thickness of all layers constituting a multilayer film.

A multilayer film of the present invention, which has a layer configuration of a PO layer (A), an adhesive resin layer (B) and an EVOH resin composition layer (C) laminated in this sequence, tends to have excellent bending resistance. With the EVOH resin composition layer (C) containing a hydrophobic plasticizer (c2) in 0.1% by mass or more and 3% by mass or less, the multilayer film tends to have excellent appearance and quality stability even though it has a layer configuration of a PO layer (A), an adhesive resin layer (B) and an EVOH resin composition layer (C) laminated in this sequence. Furthermore, when the EVOH resin composition layer (C) contains a phosphoric acid compound (c3), with its content being 500 ppm or less, recyclability tends to be improved. With the EVOH resin composition layer (C) being free from Nylon 6, recyclability tends to be improved. Furthermore, with a ratio of a thickness of the EVOH resin composition layer (C) to the total thickness of the multilayer film of the present invention being 7.5% or less, recyclability tends to be improved, while appearance tends to be deteriorated. That is, the multilayer film of the present invention is an advantageous invention in that it not only can have excellent recyclability but also can prevent deterioration in appearance and bending resistance due to its structure and furthermore can prevent possible deterioration in quality stability due to addition of a plasticizer.

(PO layer (A))

With a PO layer (A), the multilayer film of the present invention tends to be excellent in recyclability and bending resistance. The polyolefin resin as a main component of the PO layer (A) is contained in more than 50% by mass, preferably 70% by mass or more, more preferably 90% by mass or more, further preferably 95% by mass or more, optionally 99% by mass or more, optionally 100% by mass in the PO layer (A).

A density of the polyolefin resin constituting the PO layer (A) is preferably 0.850 g/cm3 or more and 0.970 g/cm3 or less in the light of bending resistance.

The density is more preferably 0.930 g/cm3 or less, further preferably 0.920 g/cm3 or less, particularly preferably 0.910 g/cm3 or less.

Examples of the polyolefin resin include olefin homopolymers or copolymers such as a linear low density polyethylene (LLDPE), a low density polyethylene (LDPE), a very low density polyethylene (VLDPE), a medium density polyethylene (MDPE), a high density polyethylene (HDPE), an ethylene-vinyl acetate copolymer (EVA), an olefin-unsaturated carboxylic acid copolymer ionomer, an ethylene-propylene copolymer, an ethylene-acrylic acid ester copolymer, a polypropylene, a propylene-α-olefin (α-olefin having 4 to 20 carbon atoms) copolymer, a polybutene and a polypentene; these olefin homopolymers or copolymers graft-modified with an unsaturated carboxylic acid or an ester thereof; and blends of these. In particular, preferred is at least one selected from the group consisting of a low density polyethylene, a medium density polyethylene, a high density polyethylene, a linear low density polyethylene and a polypropylene. In the light of bending resistance, a linear low density polyethylene (LLDPE) or a low density polyethylene (LDPE) is more preferable, and a linear low density polyethylene (LLDPE) is further preferable.

The above polyolefin resin is preferably a metallocene polyolefin produced by polymerization using a metallocene catalyst, more preferably an ethylene polymer or copolymer produced by polymerization using a metallocene catalyst. An ethylene polymer or copolymer produced by polymerization using a metallocene catalyst is an ethylene homopolymer or a copolymer of ethylene with an α-olefin having 3 or more carbon atoms, which is produced by polymerizing ethylene or copolymerizing ethylene with the α-olefin having 3 or more carbon atoms in the presence of a catalyst composed of a transition metal of IV group in a periodic table having at least one ligand having a cyclopentadienyl skeleton, preferably a zirconium compound, an organoaluminum oxy-compound, and various components which are added as necessary.

Examples of an α-olefin having 3 or more carbon atoms in the above ethylene copolymer include propylene, 1-butene, 1-pentene, 1-hexene, 1-octene, 1-decene, 1-dodecene and 4-methyl-1-pentene. The ethylene copolymer is particularly preferably a copolymer of ethylene with an α-olefin having 3 to 12 carbon atoms.

An ethylene polymer or copolymer made by polymerization using a metallocene catalyst is industrially produced and commercially available; for example, “KERNEL” (Japan Polychem Corporation), “Evolue” (Prime Polymer Co., Ltd.), “Exact” (ExxonMobile Chemical), and “AFFINITY” “ENGAGE” (Dow Chemical).

The polyolefin resin can be used alone or in combination of two or more.

A thickness per one PO layer (A) is preferably 10 μm or more, more preferably 15 μm or more. Meanwhile, a thickness per one PO layer (A) is preferably 350 μm or less, more preferably 300 μm or less, sometimes preferably 150 μm or less, 100 μm or less, 75 μm or less. With a thickness per one PO layer (A) being within the above range, bending resistance and heat-sealing properties tend to be excellent. The total thickness of all PO layers (A) constituting the multilayer film of the present invention is preferably 20 μm or more and 350 μm or less, sometimes preferably 30 μm or more and 200 μm or less, 40 μm or more and 150 μm or less.

A ratio of a thickness of the PO layer (A) to the total thickness of the multilayer film of the present invention is preferably 70% or more, more preferably 75% or more, further preferably 80% or more. With a thickness of the PO layer (A) being 70% or more, recyclability and bending resistance tend to be excellent. The thickness ratio of the PO layer (A) can be 98% or less.

(EVOH resin composition layer (C))

A multilayer film of the present invention has improved gas barrier properties because it contains an EVOH resin composition layer (C). The EVOH resin composition layer (C) contains an EVOH resin (c1) in 60% by mass or more and 99.9% by mass or less and a hydrophobic plasticizer (c2) in % by mass or more and 3% by mass or less, and is free from Nylon 6. The EVOH resin composition layer (C) has improved gas barrier properties because it contains the EVOH resin (c1) in 60% by mass or more and 99.9% by mass or less. A content of the EVOH resin (c1) is preferably 99.7% by mass or less, more preferably 99.4% by mass or less, further preferably 99.2% by mass or less. The EVOH resin (c1) is a copolymer essentially consisting of ethylene units and vinyl alcohol units, and can be produced by a well-known production method, that is, saponification of vinyl ester units in an ethylene-vinyl ester copolymer.

An ethylene-unit content of the EVOH resin (c1) is 20 mol % or more, to preferably 25 mol % or more, more preferably 32 mol % or more, further preferably 35 mol % or more, particularly preferably 42 mol % or more, sometimes preferably 45 mol % or more. Meanwhile, the ethylene-unit content is 60 mol % or less, more preferably 55 mol % or less, sometimes preferably 50 mol % or less. With an ethylene-unit content of the EVOH resin (c1) being within the above range, gas barrier properties and recyclability tend to be improved.

An average ethylene-unit content of the EVOH resin (c1) constituting the EVOH resin composition layer (C) is 30 mol % or more and 60 mol % or less. If an average ethylene-unit content is less than 30 mol %, thermal stability during melt forming may be lowered, leading to deterioration in recyclability. For example, when an EVOH with an ethylene-unit content of 29 mol % is used alone as an EVOH resin (c1), recyclability tends to be deteriorated. In contrast, even when for example, an EVOH with an ethylene-unit content of 29 mol % is used as an EVOH resin (c1), the concurrent use of another EVOH resin (c1) tends to improve recyclability with an average ethylene-unit content of the EVOH resin (c1) is 30 mol % or more and 60 mol % or less. An average ethylene-unit content is preferably 32 mol % or more, more preferably 44 mol % or more. If an average ethylene-unit content is more than 60 mol %, gas barrier properties may be insufficient. An average ethylene-unit content is preferably mol % or less.

A saponification degree of the EVOH resin (c1) is 90 mol % or more. If a saponification degree is less than 90 mol %, crystallinity of the EVOH is lower, resulting in deterioration of gas barrier properties and significant deterioration of thermal stability during melt forming. A saponification degree is suitably 95 mol % or more, more suitably 98 mol % or more, further suitably 99 mol % or more.

The EVOH resin (c1) can contain ethylene units, and vinyl ester units and other monomer units other than a saponified product of the vinyl ester. When the EVOH resin (c1) contains the other monomer units, a content of the other monomer units based on the total structural units of the EVOH resin (c1) is preferably 30 mol % or less, more preferably 20 mol % or less, further preferably 10 mol % or less, particularly preferably 5 mol % or less.

Furthermore, when the EVOH resin (c1) contains units derived from the above other monomer, its lower limit can be 0.05 mol %, or 0.10 mol %. Examples of the other monomer include alkenes such as propylene, butylene, pentene, and hexene; alkenes having an ester group or a saponified product thereof such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene and 1,3-diacetoxy-2-methylenepropane; unsaturated acids or anhydrides, salts or mono- or di-alkyl esters thereof such as acrylic acid, methacrylic acid, crotonic acid and itaconic acid; nitriles such as acrylonitrile and methacrylonitrile; amides such as acrylamide and methacrylamide; olefinic sulfonic acids or salts thereof such as vinylsulfonic acid, allylsulfonic acid and methallyl sulfonic acid; vinylsilanes such as vinyltrimethoxysilane, vinyltriethoxysilane, vinyltri(β-methoxy-ethoxy)silane, and γ-methacryloxypropylmethoxysilane; alkyl vinyl ethers; vinyl ketone; N-vinylpyrrolidone; vinyl chloride; and vinylidene chloride. The EVOH resin (c1) may be post-modified by a method such as urethanization, acetalization, cyanoethylation, or oxyalkylenation.

The EVOH resin (c1) can be used alone or in combination of two or more. When the EVOH resin (c1) is a combination of two or more, it is preferable that an EVOH resin with an ethylene-unit content of 34 mol % or less and an EVOH resin with an ethylene-unit content of 42 mol % or more are combined in the light of improving thermoformability while maintaining gas barrier properties, and more preferably an EVOH resin with an ethylene-unit content of 32 mol % or less and an EVOH resin with an ethylene-unit content of 42 mol % or more are combined. When an EVOH resin with an ethylene-unit content of 34 mol % or less and an EVOH resin with an ethylene-unit content of 42 mol % or more are combined, a mass ratio (W34/W42) of the EVOH resin with an ethylene-unit content of 34 mol % or less to the EVOH resin with an ethylene-unit content of 42 mol % or more is preferably 50/50 or more, more preferably or more, further preferably 70/30 or more in the light of gas barrier properties. The mass ratio (W34/W42) can be 90/10 or less, or 85/15 or less.

With the EVOH resin composition layer (C) containing the hydrophobic plasticizer (c2) in 0.1% by mass or more and 3% by mass or less, the multilayer film of the present invention tends to have good appearance while maintaining quality stability. The inventors have first found that a problem of deterioration in appearance arises when a ratio of a thickness of the EVOH resin composition layer (C) to the total thickness of the multilayer film of the present invention is 7.5% or less, and furthermore, the inventors have first found that the problem can be solved by adding a certain amount of the hydrophobic plasticizer (c2). Therefore, appearance is not deteriorated in a multilayer film with the thickness ratio of more than 7.5%, and thus the hydrophobic plasticizer (c2) is not effective for improving appearance. If a hydrophilic plasticizer is used in place of the hydrophobic plasticizer (c2), quality stability tends not to be maintained. A content of the hydrophobic plasticizer (c2) in the EVOH resin composition layer (C) is 0.1% by mass or more, preferably 0.3% by mass or more, more preferably 0.6% by mass or more, further preferably 0.8% by mass or more. If a content of the hydrophobic plasticizer (c2) is less than 0.1%, poor appearance due to unevenness (stripe-shaped irregularity or irregular surface like an orange peel) which generates after co-extrusion forming of a multilayer film becomes remarkable. Meanwhile, a content of the hydrophobic plasticizer (c2) is 3% by mass or less, more preferably 2.5% by mass or less. If a content of the hydrophobic plasticizer (c2) is more than 3% by mass, a resin pressure in an extruder for the EVOH resin composition layer (C) is unstable during forming a multilayer film of the present invention, and thus a thickness of the EVOH layer may be unstable, so that product stability cannot be maintained.

There are no particular restrictions to the hydrophobic plasticizer (c2) as long as it is hydrophobic; for example, aliphatic esters and aromatic esters, and preferably aliphatic esters in the light of further improving appearance of a multilayer film of the present invention.

Suitable aliphatic esters include mono-, di- or more polyvalent esters of a polyol (divalent, trivalent or more polyvalent alcohol) with a higher fatty acid (higher fatty acid with 8 or more, suitably 8 to 30 carbon atoms). By way of example, stearate esters include glycerin monostearate, glycerin monol2-hydroxystearate, glycerin distearate, diglycerin monostearate and tetraglycerin monostearate, and laurate esters include glycerin monolaurate, diglycerin monolaurate and tetraglycerin monolaurate. Examples of other aliphatic acid esters include polypropylene adipate, diisodecyl adipate, bis(2-methylhexyl) adipate, dicapryl adipate, diisooctyl adipate, octyl decyl adipate, isooctyl isodecyl adipate, dibutyl fumarate, dioctyl fumarate, triethyl citrate, acetyl triethyl citrate, tributyl citrate and acetyl tributyl citrate.

Examples of aromatic esters include dibutyl phthalate, dioctyl phthalate, diheptyl phthalate, bis(2-ethylhexyl) phthalate, dicyclohexyl phthalate, butyl lauryl phthalate, diisooctyl phthalate, butyl coconutalkyl phthalate, ditridecyl phthalate, dilauryl phthalate, diisodecyl phthalate, butyl benzyl phthalate, octyl decanoyl phthalate, dimethylglycol phthalate, ethylphthalylethylene glycolate, methylphthalylethylene glycolate, butylphthalylbutylene glycolate, dinonyl phthalate, diheptyl phthalate, octyldecyl phthalate, ditridecyl phthalate, dicapril phthalate, bis(3,5,5-trimethylhexyl) phthalate, isooctyl isodecyl phthalate, bis(diethyleneglycol monomethyl ether) phthalate, and benzophenol.

The hydrophobic plasticizer (c2) can be used alone or in combination of two or more. When two or more are combined as the hydrophobic plasticizer (c2), it is preferable in the light of consistent appearance-improving effect that the EVOH resin composition layer (C) contains each hydrophobic plasticizer (c2) in 0.05% by mass or more. Although the reason is unclear, it is supposed that an error in the addition amount of less than 0.05% by mass may influence appearance-improving effect.

The EVOH resin composition layer (C) can further contain a phosphoric acid compound (c3). When the EVOH resin composition layer (C) contains the phosphoric acid compound (c3), its content is 500 ppm or less in terms of phosphoric acid radical. If a content of the phosphoric acid compound is more than 500 ppm in terms of phosphoric acid radical, recyclability is deteriorated. A content of the phosphoric acid compound is preferably 300 ppm or less, more preferably 200 ppm or less, sometimes preferably 150 ppm or less and 100 ppm or less in terms of phosphoric acid radical. Meanwhile, a content of the phosphoric acid compound is preferably 10 ppm or more, more preferably 20 ppm or more in terms of phosphoric acid radical. With a content of the phosphoric acid compound being 10 ppm or more, a recovered composition tends to have improved hue.

There are no particular restrictions to the phosphoric acid compound (c3); various acids such as phosphoric acid and phosphorous acid and salts or the like thereof can be used. A phosphoric acid salt can be contained as any form including monobasic phosphates, dibasic phosphates and tribasic phosphates, preferably monobasic phosphates. There are no particular restrictions to its cationic species; preferably alkali metal salts. Among these, preferred are sodium dihydrogen phosphate and potassium dihydrogen phosphate.

The EVOH resin composition layer (C) may preferably contain a thermoplastic resin (c4) for improving recyclability and bending resistance of a multilayer film of the present invention. In general, when the EVOH resin composition layer contains the thermoplastic resin (c4), appearance of the multilayer film tends to be deteriorated, but with the EVOH resin composition layer (C) containing the hydrophobic plasticizer (c2), recyclability and bending resistance of the multilayer film can be improved without deteriorating appearance. That is, with the EVOH resin composition layer (C) containing the thermoplastic resin (c4), appearance-improving effect by the hydrophobic plasticizer (c2) tends to be more remarkable. When the EVOH resin composition layer (C) contains the thermoplastic resin (c4), a mass ratio (c4/c1) of the thermoplastic resin (c4) to the EVOH resin (c1) is 10/90 or more and or less. The mass ratio (c4/c1) is preferably 15/85 or more and 35/65 or less, more preferably 20/80 or more and 30/70 or less. With the mass ratio (c4/c1) being within the above range, recyclability and bending resistance of the multilayer film tend to be improved.

There are no particular restrictions to the thermoplastic resin (c4) as long as it is a thermoplastic resin other than the EVOH resin (c1) and Nylon 6, and it preferably contains at least one selected from the group consisting of an acid-modified polyolefin, an EVOH resin with an ethylene-unit content of more than 60 mol %, Nylon 6/12, Nylon 6/66 and Nylon 6/66/12, and it is more preferably at least one selected from the group consisting of these.

With the thermoplastic resin (c4) containing an acid-modified polyolefin, recyclability and bending resistance of the multilayer film of the present invention tend to be improved. With the thermoplastic resin (c4) containing an acid-modified polyolefin, the thermoplastic resin (c4) preferably contains an acid-modified polyolefin and an unmodified polyolefin, and more preferably consists of an acid-modified polyolefin and an unmodified polyolefin in the light of further improving recyclability.

The unmodified polyolefin can be as mentioned for the polyolefin resin contained in the PO layer (A), and among these, an LLDPE or an ethylene-α-olefin copolymer is preferable; an ethylene-α-olefin copolymer is more preferable; and an ethylene-propylene copolymer is further preferable. An acid-modified polyolefin can be suitably an acid-modified polyolefin containing a carboxy group or anhydride thereof obtained by chemically bonding (for example, addition reaction, graft reaction, copolymerization and the like) an ethylenic unsaturated carboxylic acid or anhydride thereof, more suitably a maleic anhydride-modified polyolefin. A polyolefin for introducing an acid-modified group can be suitably as mentioned for the above unmodified polyolefin. Among these, the acid-modified polyolefin containing a carboxy group or anhydride thereof is preferably a maleic anhydride-modified ethylene-α-olefin copolymer, more preferably a maleic anhydride-modified ethylene-propylene copolymer.

With the thermoplastic resin (c4) containing an EVOH with an ethylene-unit content of more than 60 mol %, recyclability and bending resistance of the multilayer film of the present invention tend to be improved. When the thermoplastic resin (c4) contains an EVOH with an ethylene-unit content of more than 60 mol %, the thermoplastic resin (c4) is preferably an EVOH with an ethylene-unit content of more than 60 mol %. A suitable aspect of the EVOH with an ethylene-unit content of more than 60 mol % is as mentioned for the EVOH resin (c1) except an ethylene-unit content. An ethylene-unit content of the EVOH with an ethylene-unit content of more than 60 mol % is preferably 65 mol % or more and 90 mol % or less, more preferably 70 mol % or more and 85 mol % or less. With an ethylene-unit content of the EVOH with an ethylene-unit content of more than 60 mol % being within the above range, recyclability and bending resistance of the multilayer film tend to be improved.

When the thermoplastic resin (c4) contains at least one selected from the group consisting of Nylon 6/12, Nylon 6/66 and Nylon 6/66/12, bending resistance tends to be improved while hue of a recovered composition tends to be deteriorated. When the thermoplastic resin (c4) contains at least one selected from the group consisting of Nylon 6/12, Nylon 6/66 and Nylon 6/66/12, the thermoplastic resin (c4) is preferably at least one selected from the group consisting of Nylon 6/12, Nylon 6/66 and Nylon 6/66/12. Here, if the thermoplastic resin (c4) is Nylon 6, recyclability of the multilayer film of the present invention is disadvantageously deteriorated.

As long as the effects of the present invention are not impaired, the EVOH resin composition layer (C) can contain other components such as a carboxylic acid compound, a boron compound, an alkali metal salt, an alkaline-earth metal salt, an antiblocking agent, a process aid, a stabilizer, an antioxidant, an ultraviolet absorber, an antistatic agent, a lubricant, a colorant, a filler, a drying agent, a cross-linking agent and a reinforcing agent including various fibers. The EVOH resin composition layer (C) can contain a nonionic surfactant other than the hydrophobic plasticizer (c2), but preferably, it does not contain it. When the hydrophobic plasticizer (c2) corresponds to a nonionic surfactant, it is preferable in the light of improving appearance that the EVOH resin composition layer (C) contains such a nonionic surfactant (hydrophobic plasticizer (c2)) in at least 0.05% by mass or more.

With the EVOH resin composition layer (C) containing a carboxylic acid compound, coloration during melt forming tends to be prevented. A carboxylic acid compound contained in the EVOH resin composition layer (C) can be a monocarboxylic acid or polycarboxylic acid, or a combination thereof. A carboxylic acid compound contained in the EVOH resin composition layer (C) can be ionic, and such a carboxylate ion can form a salt with a metal ion. The carboxylic acid compound is preferably an aliphatic carboxylic acid, particularly suitably acetic acid.

When the EVOH resin composition layer (C) contains a boron compound, torque fluctuation during heating and melting tends to be suppressed. Examples of the boron compound include, but not limited to, boric acids, boric acid esters, boric acid salts and boron hydrides. Specific examples include boric acids such as orthoboric acid, metaboric acid and tetraboric acid; boric acid esters such as triethyl borate and trimethyl borate; and boric acid salts such as alkali metal salts and alkaline-earth metal salts of each boric acid as mentioned above, and borax. Among these compounds, orthoboric acid (hereinafter, sometimes simply referred to as “boric acid”) is preferable. When the EVOH resin composition layer (C) contains a boron compound, a content of the boron compound is preferably 20 to 2000 ppm in terms of a boron element. With a content of the boron compound being 20 ppm or more, torque fluctuation during heating and melting tends to be suppressed, and the content is more preferably 50 ppm or more. Meanwhile, with a content of the boron compound being 2000 ppm or less, formability tends to be improved, and the content is more preferably 1000 ppm or less.

When the EVOH resin composition layer (C) contains an alkali metal salt, interlayer adhesiveness between the EVOH resin composition layer (C) and an adhesive resin layer (B) in a multilayer film of the present invention tends to be improved. A cationic species for an alkali metal salt is preferably, but not limited to, sodium or potassium. There are also no restrictions to an anionic species for an alkali metal salt. It can be added as a carboxylate, a carbonate, a hydrogen carbonate, a phosphate, a hydrogen phosphate, a borate or a hydroxide. When the EVOH resin composition layer (C) contains an alkali metal salt, a content of the alkali metal salt is preferably 10 to 500 ppm in terms of a metal element. The content of the alkali metal salt is more preferably 50 ppm or more. Meanwhile, with a content of the alkali metal salt being 500 ppm or less, melt stability tends to be improved, and the content is more preferably 300 ppm or less.

When the EVOH resin composition layer (C) contains an alkaline earth metal salt, degradation of the resin and generation of degraded materials such as a gel during repeated melt forming tend to be suppressed. Examples of a cationic species for the alkaline earth metal salt include preferably, but not limited to, magnesium and calcium. There are also no particular restrictions to an anionic species for the alkaline earth metal salt. It can be added as a carboxylate, a carbonate, a hydrogen carbonate, a phosphate, a hydrogen phosphate, a borate or a hydroxide.

Examples of an anti-blocking agent include inorganic oxides, inorganic nitrides and inorganic oxynitrides such as those of silicon, aluminum, magnesium, zirconium, cerium, tungsten and molybdenum. Among these, silicon oxide is desirable because of its availability.

Examples of a process aid include fluorinated process aids such as Kynar™ from Arkema S. A. and Dynamar™ from3M. With the EVOH resin composition layer (C) containing a process aid, adhesion of a depleted EVOH in an extruder and a die for the EVOH resin composition layer (C) during forming a multilayer film tends to be prevented.

Examples of a stabilizer for improving melt stability or the like include hydrotalcite compounds, hindered phenols, hindered amine thermal stabilizers, metal salts of a higher aliphatic carboxylic acid (for example, calcium stearate, magnesium stearate, and the like). When the EVOH resin composition layer (C) contains a stabilizer, its content is preferably 0.001 to 1 mass %.

Examples of an antioxidant include 2,5-di-t-butyl-hydroquinone, 2,6-di-t-butyl-p-cresol, 4,4′-thiobis-(6-t-butylphenol), 2,2′-methylene-bis-(4-methyl-6-t-butylphenol), octadecyl-3-(3′,5′-di-t-butyl-4′-hydroxyphenyl) propionate, and 4,4′-thiobis-(6-t-butylphenol).

Examples of a UV absorber include ethylene-2-cyano-3′,3′-diphenylacrylate, 2-(2′-hydroxy-5′-methylphenyl) benzotriazole, 2-(2′-hydroxy-3′-t-butyl-5′-methyl phenyl)5-chlorobenzotriazole, 2-hydroxy-4-methoxybenzophenone, and 2,2′-dihydroxy-4-methoxybenzophenone.

Examples of a drying agent include sodium phosphate (Na₃PO₄), disodium hydrogenphosphate (Na₂HPO₄), sodium dihydrogenphosphate

(NaH₂PO₄), sodium polyphosphate, lithium phosphate, dilithium hydrogenphosphate, lithium dihydrogenphosphate, lithium polyphosphate, potassium phosphate, dipotassium hydrogenphosphate, potassium dihydrogenphosphate, potassium polyphosphate, calcium phosphate (Ca₃(PO₄)₂), calcium hydrogenphosphate (CaHPO₄), calcium dihydrogenphosphate (Ca(H₂PO₄)₂), calcium polyphosphate, ammonium phosphate, diammonium hydrogenphosphate, ammonium dihydrogenphosphate and ammonium polyphosphate. Here, polyphosphate salts include diphosphates (pyrophosphates) and triphosphates (tripolyphosphates). Among these phosphate salts, preferred are anhydrates which are free from crystal water. However, if a weight of the above drying agent in the EVOH resin composition layer (C) is more than 500 ppm, thermal stability of the EVOH resin composition layer (C) is deteriorated, leading to deterioration of recyclability of the multilayer film of the present invention.

Examples of a lubricant include ethylenebisstearamide and butyl stearate.

Examples of a colorant include carbon black, phthalocyanine, quinacridone, indoline, azo pigments, and bengalla.

Examples of a filler include fiberglass, asbestos, ballastite, and calcium silicate.

A proportion of the EVOH resin (c1) and the hydrophobic plasticizer (c2) in the EVOH resin composition layer (C) is preferably 65% by mass or more, sometimes more preferably 70% by mass or more, 80% by mass or more, % by mass or more, or 95% by mass or more, and the EVOH resin composition layer (C) can substantially consist of the EVOH resin (c1) and the hydrophobic plasticizer (c2). When the EVOH resin composition layer (C) contains the thermoplastic resin (c4), a proportion of the EVOH resin (c1), the hydrophobic plasticizer (c2) and the thermoplastic resin (c4) in the EVOH resin composition layer (C) is preferably 70% by mass or more, more preferably % by mass or more, further preferably 90% by mass or more, particularly preferably 95% by mass or more, optionally 98% by mass or more or 99% by mass or more, and the EVOH resin composition layer (C) can substantially consist of the EVOH resin (c1), the hydrophobic plasticizer (c2) and the thermoplastic resin (c4).

There are no particular restrictions to a method for preparing a resin composition of the EVOH resin composition layer (C); for example, it can be prepared by blending or kneading the EVOH resin (c1) and the hydrophobic plasticizer (c2) under the conditions of melting the former. When the above resin composition is produced, in the method for producing a multilayer film described later, the EVOH resin (c1) and the hydrophobic plasticizer (c2) can be dry-blended or alternatively the EVOH resin (C) and the hydrophobic plasticizer (c2) can be dry-blended followed by melt-kneading to pre-prepare resin composition pellets, in forming the EVOH resin composition layer (C). When the EVOH resin composition layer (C) contains the thermoplastic resin (c4), it can be concurrently dry-blended with the EVOH resin (c1) and the hydrophobic plasticizer (c2). When the EVOH resin composition layer (C) contains the phosphoric acid compound (c3) and other components, they can be dry-blended with the EVOH resin (c1) and the hydrophobic plasticizer (c2), or they can be preliminarily contained in the EVOH resin (c1). The phosphoric acid compound (c3) and the other components can be preliminarily contained in the EVOH resin (c1) by, for example, immersing the EVOH resin (c1) in a solution containing the phosphoric acid compound (c3) and the other components; adding such a solution to the EVOH resin (c1), or dry-blending various additives followed by melt-kneading them. It is preferable in the light of improving adhesion strength of a multilayer film obtained that in forming the EVOH resin composition layer (C) (without preliminarily producing resin composition pellets), these components are dry-blended. Mixing or kneading under melting conditions can be conducted by using a known mixer or kneader such as a kneader-ruder, an extruder, a mixing roll and a Banbury mixer. A temperature during melt kneading is generally 110 to 300° C.

A thickness of one layer of the EVOH resin composition layer (C) is preferably 1 μm or more, more preferably 2 μm or more. Meanwhile, a thickness of one layer of the EVOH resin composition layer (C) is preferably 30 μm or less, more preferably 25 μm or less. With a thickness of one layer of the EVOH resin composition layer (C) being within the above range, gas barrier properties of the multilayer film tends to be stable, and bending resistance tends to be improved. The total thickness of the whole layers of the EVOH resin composition layer (C) constituting the multilayer film of the present invention is preferably 1 μm or more and 30 μm or less.

A ratio of a thickness of the EVOH resin composition layer (C) to the total thickness of the multilayer film of the present invention is 7.5% or less, preferably 6.5% or less, more preferably 5% or less. If the thickness ratio is more than 7.5%, appearance defects in the multilayer film can be prevented, but bending resistance and recyclability are deteriorated. The thickness ratio is preferably 1% or more, more preferably 2% or more. Meanwhile, the thickness ratio is preferably 6.5% or less, more preferably 5% or less. If the thickness ratio for the EVOH resin composition layer (C) is less than 1%, thickness uniformity of the EVOH resin composition layer (C) may be insufficient.

(Adhesive resin layer (B))

With the multilayer film of the present invention containing the adhesive resin layer (B), adhesiveness between the PO layer (A) and the EVOH resin composition layer (C) tends to be improved, resulting in improvement of bending resistance. Furthermore, the adhesive resin layer (B) may play a role as a compatibilizing agent for the PO layer (A) and the EVOH resin composition layer (C), resulting in improvement of recyclability. A proportion of an adhesive resin in the adhesive resin layer (B) is preferably 5% by mass or more, more preferably 30% by mass or more, further preferably 70% by mass or more, particularly preferably 95% by mass or more, optionally 99% by mass or more or 100% by mass.

The adhesive resin used in the adhesive resin layer (B) can be, for example, a modified-olefin polymer containing a carboxyl group obtained by chemically binding an unsaturated carboxylic acid or an anhydride thereof to an olefin polymer by addition reaction, graft reaction or the like. Examples of an unsaturated carboxylic acid or an anhydride thereof include maleic acid, maleic anhydride, fumaric acid, acrylic acid, methacrylic acid, crotonic acid, itaconic acid, citraconic acid and hexahydrophthalic anhydride, and among these, maleic anhydride is suitably used. Specifically, preferred are one or a mixture of two or more selected from the group consisting of a maleic anhydride graft-modified polyethylene, a maleic anhydride graft-modified polypropylene, a maleic anhydride graft-modified ethylene-propylene copolymer, a maleic anhydride graft-modified ethylene-ethyl acrylate copolymer and a maleic anhydride graft-modified ethylene-vinyl acetate copolymer.

Adhesiveness may be improved by blending a rubber/elastomer component such as a polyisobutyrene and an ethylene-propylene rubber or a polyolefin resin other than a polyolefin resin as an adhesive resin substrate in the adhesive resin layer (B).

A thickness of one layer of the adhesive resin layer (B) is preferably 1 μm or more, more preferably 2 μm or more. Meanwhile, a thickness of one layer of the adhesive resin layer (B) is preferably 20 μm or less, more preferably 15 μm or less. With a thickness of one layer of the adhesive resin layer (B) being within the above range, interlayer adhesive force between the EVOH resin composition layer (C) and the adhesive resin layer (B) tends to be improved. The total thickness of the whole layers of the adhesive resin layer (B) constituting the multilayer film of the present invention is preferably 2 μm or more and 40 μm or less.

A ratio of a thickness of the adhesive resin layer (B) to the total thickness of the multilayer film of the present invention is preferably 1% or more, more preferably 2% or more, further preferably 3% or more. The thickness ratio of the adhesive resin layer (B) is preferably 15% or less, more preferably 10% or less.

(Multilayer film)

There are no particular restrictions to the multilayer film of the present invention as long as it has a layer configuration wherein a PO layer (A), an adhesive resin layer (B) and an EVOH resin composition layer (C) are laminated in this sequence. Each layer can be laminated either directly or via another layer, and in the light of preventing interlayer delamination, the film preferably has a layer configuration wherein a PO layer (A), an adhesive resin layer (B) and an EVOH resin composition layer (C) are directly laminated in this sequence.

The multilayer film of the present invention can have a layer (D) made of a thermoplastic resin other than the PO layer (A), the adhesive resin layer (B) or the EVOH resin composition layer (C), and/or a recovered material layer® made of a recovered composition described later. The thermoplastic resin constituting the thermoplastic resin layer (D) is preferably a thermoplastic resin with a melting point of lower than 210° C. in the light of inhibiting deterioration of recyclability of the multilayer film of the present invention. Examples of a thermoplastic resin with a melting point of lower than 210° C. include, but not limited to, polystyrene resins, acrylic resins, vinyl ester resins, polyurethane resins and polycarbonate resins. A layer (D) made of a thermoplastic resin with a melting point of higher than 210° C. such as polyamide resins including Nylons and polyesters is undesirable because it deteriorates recyclability of the multilayer film of the present invention. When the multilayer film of the present invention contains a polyamide resin as the thermoplastic resin layer (D), a proportion of polyamide resins in a recovered composition obtained by recovering the multilayer film of the present invention is so increased that recyclability is affected. However, when the EVOH resin composition layer (C) contains a small amount of a particular polyamide resin, recyclability may not be so affected, so that it may be preferable in the light of improving bending resistance as described above.

There are no particular restrictions to a layer configuration of the multilayer film of the present invention as long as it has a layer configuration wherein the PO layer (A), the adhesive resin layer (B) and the EVOH resin composition layer (C) are laminated in this sequence, and the following configurations are exemplified. In the following examples, “A” represents a PO layer (A); “B” represents an adhesive resin layer (B); “C” represents an EVOH resin composition layer (0); “D” represents a thermoplastic resin layer (D); and “I” represents that the layers are directly laminated.
3 layers: A/B/C
5 layers: A/B/C/B/A, A/B/C/B/D
6 layers: A/B/C/B/D/A, D/A/B/C/B/A, A/D/B/C/B/D, D/A/B/C/B/D
7 layers: A/D/B/C/B/D/A, A/D/B/C/B/ND, D/A/B/C/B/A/D, A/B/C/B/C/B/A
9 layers: A/D/B/C/B/C/B/D/A, A/D/B/C/B/C/B/ND, D/A/B/C/B/C/B/A/D, A/B/C/B/D/B/C/B/A, D/B/C/B/D/B/C/B/A
   Among these, preferred a multilayer film having a layer configuration of A/B/C/B/A. Here, a recovered layer (R) is a layer containing a polyolefin resin as a main component, so that it can be used in place of the PO layer (A) or can be directly laminated on the PO layer (A). When the multilayer film of the present invention has a plurality of the PO layers (A), the adhesive resin layers (B) or the EVOH resin composition layers (C), these layers can be the same as or different from each other.

In the light of heat-sealing properties of the PO layer (A), the total thickness of the multilayer film of the present invention is preferably 20 μm or more, more preferably 30 μm or more. In the light of bending resistance, the total thickness of the multilayer film of the present invention is less than 400 μm, preferably 300 μm or less, sometimes preferably 250 μm or less, 200 μm or less, or 150 μm or less. For the multilayer structure with the total thickness of the whole layers being 400 μm or more, appearance defect tends not to occur. Therefore, appearance defect, a problem of the present invention, is remarkable when the total thickness is less than 400 μm and a ratio of a thickness of the EVOH resin composition layer (C) to the total thickness of the multilayer film is 7.5% or less.

Adhesion strength between the EVOH resin composition layer (C) and the adhesive resin layer (B) in the multilayer film of the present invention under the atmosphere of 23° C. and 50% RH is preferably 1.0N/15 mm or more, more preferably 2.0N/15 mm or more, further preferably 3.0N/15 mm or more. Adhesion strength of the multilayer film of the present invention can be improved by dry-blending the components when the EVOH resin composition layer (C) is formed (without preliminarily producing resin composition pellets). Adhesion strength of the multilayer film of the present invention can be measured as described in Examples.

Examples of a method for producing a multilayer film of the present invention include co-extrusion forming, extrusion lamination and co-injection forming. Examples of co-extrusion forming include co-extrusion lamination, co-extrusion sheet forming, co-extrusion inflation forming and co-extrusion blow molding.

Furthermore, another film can be laminated on the multilayer film of the present invention by dry lamination or extrusion lamination.

The multilayer film thus obtained can be further subjected to secondary processing such as thermoforming including drawing, roll stretching, pantograph stretching, inflation stretching and blow molding.

It is preferable that a recovered material (scrap), that is, end materials and defective articles generated when the multilayer film of the present invention is produced, is reused. Thus, in terms of recovering a multilayer film, out-of-specification articles generated in production can recovered, but a preferable embodiment is recovering multilayer films distributed on the market. Other preferable embodiments of the present invention include a method for producing a recovered composition comprising pulverizing a recovered material of the multilayer film of the present invention and melt forming the material, and a recovered composition comprising a recovered material of the multilayer film of the present invention.

In recovery of the multilayer film of the present invention, first, a recovered material of the multilayer film of the present invention is pulverized. The pulverized recovered material can be melt-formed as it is to provide a recovered composition, or alternatively, as needed, it can be melt-formed with another component to provide a recovered composition. The component added to the recovered material can be a polyolefin resin used for the PO layer (A). In melt forming of a recovered material of the multilayer film of the present invention, a known recycling agent can be, as needed, added. The pulverized recovered material can be directly used for production of a formed article such as a multilayer structure, or alternatively, a recovered material is melt-formed to provide pellets made of a recovered composition, which can be used for producing a formed article. The recovered material can be melt-formed by, for example, pellet forming by a single- or twin-screw extruder, cast forming, inflation forming, blow molding, compression molding, injection molding and melt spinning. A melting temperature varies depending on melting point of the copolymer and the like, but it is preferably about 150 to 270° C. The recovered composition can contain an unused polyolefin resin as described above, but a content of a recovered material in the recovered composition is preferably 5% by mass or more. The recovered composition thus obtained can be preferably used as a recovered layer (R) for a multilayer film.

In a recovered composition thus obtained, a mass ratio of the EVOH resin (c1) to the polyolefin resin [EVOH resin (c1)/polyolefin resin] is preferably to 7.5/92.5.

A food packaging material, a beverage packaging material, a medicine packaging material, a cosmetic packaging material, or an agricultural material, which is produced using of the multilayer film of the present invention is a suitable embodiment of the present invention.

The above packaging material such as a food packaging material, a beverage packaging material, a medicine packaging material and a cosmetic packaging material can be a packaged article in which such a packaging material is filled with a content. The packaged article is useful because flavor deterioration of a content by oxygen can be prevented. Examples of a content which can be charged include, but not limited to, drinks such as wine and fruit juice; foods such as fruits, nuts, vegetables, meat products, infant foods, coffee, jams, mayonnaise, ketchup, edible oils, dressings, sauces, tsukudanis, and dairy products; and other articles such as medicines and cosmetics, which tend to be deteriorated in the presence of oxygen.

### EXAMPLES

There will be more specifically described the present invention with reference to Examples, but the present invention is not limited to these examples in any way.

### Materials used in Examples and Comparative Examples (EVOH resin (c1) (some of these contain a phosphoric acid compound (c3))

c1-1: EVOH pellets, ethylene-unit content: 48 mol %, saponification degree: 99.9 mol %, MFR (190° C., load: 2.16 kg): 6.4 g/10 min, phosphoric acid content (in terms of phosphoric acid radical): 50 ppm
c1-2: EVOH pellets, ethylene-unit content: 38 mol %, saponification degree: 99.9 mol %, MFR (190° C., load: 2.16 kg): 1.7 g/10 min, phosphoric acid content (in terms of phosphoric acid radical): 50 ppm
c1-3: EVOH pellets, ethylene-unit content: 48 mol %, saponification degree: 99.9 mol %, MFR (190° C., load: load: 2.16 kg): 6.4 g/10 min, phosphoric acid content (in terms of phosphoric acid radical): 25 ppm
c1-4: EVOH pellets, ethylene-unit content: 48 mol %, saponification degree: 99.9 mol %, MFR (190° C., load: 2.16 kg): 6.4 g/10 min, phosphoric acid content (in terms of phosphoric acid radical): 300 ppm
c1-5: EVOH pellets, ethylene-unit content: 48 mol %, saponification degree: 99.9 mol %, MFR (190° C., load: 2.16 kg): 6.4 g/10 min, phosphoric acid content (in terms of phosphoric acid radical): 0 ppm
c1-6: EVOH pellets, ethylene-unit content: 27 mol %, saponification degree: 99.9 mol %, MFR (210° C., load: 2.16 kg): 4.5 g/10 min, phosphoric acid content (in terms of phosphoric acid radical): 50 ppm
c1-7: EVOH pellets, ethylene-unit content: 44 mol %, saponification degree: 99.9 mol %, MFR (190° C., load: 2.16 kg): 5.7 g/10 min, phosphoric acid content (in terms of phosphoric acid radical): 50 ppm
c1-8: EVOH pellets, ethylene-unit content: 29 mol %, saponification degree: 99.9 mol %, MFR (210° C., load: 2.16 kg): 3.8 g/10 min, phosphoric acid content (in terms of phosphoric acid radical): 50 ppm
c1-9: EVOH pellets, ethylene-unit content: 48 mol %, saponification degree: 99.9 mol %, MFR (190° C., load: 2.16 kg): 6.4 g/10 min, phosphoric acid content (in terms of phosphoric acid radical): 600 ppm

A phosphoric acid content of the EVOH resin (c1) was measured as to described in Evaluation Method (1) later.

(Hydrophobic plasticizer (c2))
GMS: glycerin monostearate
GML: glycerin monolaurate
TGML: tetraglycerin monolaurate
DEP: diethyl phthalate
DGL: diglycerin laurate
GTS: tetraglycerin stearate
   (Hydrophilic plasticizer (c2′))
GLR: glycerin
   (Thermoplastic resin (c4))
c4-1: Ube Industries, Ltd., “UBE Nylon® 7034” (PA6/12 copolymer, melting point: 201° C., relative viscosity (96% sulfuric acid, polymer concentration: 1.0 wt %): 3.86)
c4-2: Ube Industries, Ltd., “UBE Nylon® 6434” (PA6/66/12 copolymer, melting point: 188° C., relative viscosity (96% sulfuric acid, polymer concentration: 1.0 wt %): 4.05))
c4-3: Mitsui Chemicals, Inc., “Tafmer® P0280” (ethylene-propylene copolymer, MFR: 5.4 g/10 min (230° C., load: 2160 g))
c4-4: Mitsui Chemicals, Inc., “Tafmer0 MP0620” (maleic anhydride-modified ethylene-propylene copolymer, Mitsui Chemicals, Inc., MFR: 0.3 g/10 min (230° C., load: 2160 g))
c4-5: Exxon Mobil Corporation, “Exceed® 1018” (LLDPE, MFR: 1.0 g/10 min (190° C., load: 2160 g))
c4-6: Tosoh Corporation, “Melthene® H-6051” (saponified ethylene-vinyl acetate copolymer, ethylene-unit content: 89 mol %, saponification degree: 97 mol %, MFR (190° C., load: 2.16 kg): 5.5 g/10 min)
c4-7: Ube Industries, Ltd., “UBE Nylon® 1030” (PA6, melting point: 220° C., relative viscosity (96% sulfuric acid, polymer concentration: 1.0 wt %): 4.08)

### (Polyolefin Resin)

mLLDPE1: “Evolue® SP1020” (a linear low density polyethylene produced by polymerization using a metallocene catalyst, Prime Polymer Co., Ltd., density: 0.909 g/cm3)

### (Adhesive Resin)

MAH-PE1: “Admen® NF498E” (maleic anhydride-modified polyethylene, Mitsui Chemicals, Inc.)

### <Evaluation Method>

(1) Quantitation of phosphoric acid compound

In a Teflon® pressure vessel was charged 0.5 g of an EVOH resin (c1) used in Examples and Comparative Examples, and 5 mL of concentrated nitric acid was added to decompose the resin. After 30 min, a vessel was sealed with a lid. Then, decomposition was progressed by heating at 150° C. for 10 min and then at 180° C. for 5 min by a wet decomposer (Actac Co., Ltd. “MWS-2”), and then the vessel was cooled to room temperature. This process solution was transferred to a 50 mL volumetric flask (from TPX) and diluted with pure water. Elementary analysis was conducted for this solution by an ICP emission spectrophotometer (PerkinElmer, “OPTIMA4300DV”), to determine the amount of a phosphoric acid compound in terms of phosphorus atom.

### (2) Measurement of a Thickness of Each Layer of a Multilayer Film

A multilayer film produced in Examples and Comparative Examples was cut into 2 cm×2 cm pieces, whose section was then exposed using a small rotary microtome PR-50 from Yamato Kohki Industrial Co., Ltd. Then, a thickness of each layer was determined by an optical microscope (model: ECLIPSE LV100ND) from Nikon Instech Co., Ltd.

### (3) Resin Pressure Stability

Variation in a resin pressure in an extruder for an EVOH resin composition layer (C) was measured during continuously forming a multilayer film for one hour under the conditions described in Examples and Comparative Examples, and was evaluated in accordance with the criteria below. Rank “A” or “B” was deemed very stable. When a resin pressure is unstable, a discharge rate and a thickness of the EVOH resin composition layer (C) may be unstable, leading to quality variation.
A: less than ±5%
B: ±5% or more and less than ±10%
C: ±10% or more and less than ±20%
D: ±20% or more

### (4) Evaluation of Appearance of a Multilayer Film

The center in the width direction of a multilayer film obtained in Examples and Comparative Examples was cut into a 10 cm×10 cm square, whose appearance was then visually observed to evaluate in accordance with the criteria below. Rank “A” or “B” was deemed excellent in appearance evaluation. “Unevenness” described in the criteria below means fine unevenness (interface unevenness) generated in an interface between the EVOH resin composition layer (C) and the adhesive resin layer (B), which can be visually observed as a stripe-shaped irregularity or irregular surface like an orange peel.
A: Unevenness was not observed.
B: Unevenness was observed in some part.
C: Significant unevenness was observed over the whole film.
D: The whole film became turbid.

### (5) Bending Resistance of a Multilayer Film

A multilayer film obtained in Examples and Comparative Examples was humidity-conditioned under the conditions of 23° C. /50% RH, and then was subjected to bending measurement using Gelbo Flex Tester (Tester Sangyo Co., Ltd., BE-1005). Specifically, first a 12 inch×8 inch film was formed into a cylinder with a diameter of 3.5 inches, whose ends were gripped while it was twisted at the initial 3.5 inches of the stroke by an angle of 440° with an initial grip interval of 7 inches and a grip interval at the maximum bending of 1 inch, and then at 2.5 inches was subjected to a reciprocating motion consisting of straight horizontal movement at a speed of 40 times/min, and the presence of pinholes after 1000 times of the reciprocating motion was evaluated. For to determining the number of pinholes, the multilayer film after the bending test was set on a white paper, a red ink was applied over the whole surface of the multilayer film. After the multilayer film was removed, the number of ink spots observed on the white paper was counted as the number of pinholes, which was evaluated in accordance with the criteria below. Rank “A” or “B” was deemed excellent in bending resistance.
A: No pinholes.
B: The number of pinholes is 1 to 10.
C: The number of pinholes is more than 10.

### (6) Test of a Recovered Composition

### (6-1) Recyclability (Fisheyes)

A multilayer film obtained in Examples and Comparative Examples was pulverized to give a pulverized material (recovered material), which was used to form a monolayer film with a thickness of 20 μm using a 20 mmcp extruder. The film was wound to a paper core with a diameter of 3 inch to prepare a monolayer film.

### <Conditions of Preparation of a Monolayer Film>

Apparatus: 20 mmcp single screw extruder (Toyo Seiki Seisaku-sho, Ltd., Labo Plastomill 15C300)
L/D: 20
Screw: full flight
Die: 300 mm coathanger die
Extrusion temperature (° C.): C1=200, C2 to C5=230, Die=230
Screen: 50/100/50
Cooling roll temperature: 80° C.
Take-up speed: 3.0 to 3.5 m/min
Film thickness: 20 μm

Thirty minutes after initiation of monolayer film formation, the number of fisheyes observed per a unit area of the monolayer film obtained (number/m²) was determined using a fisheye counter from Frontier System Inc. (model: ZD/AD1). Rank “A”, “B” or “C” was deemed excellent in recyclability.
A: less than 500/m²
B: 500/m² or more and less than 750/m²
C:750/m² or more and less than 1000/m²
D: 1000/m² or more and less than 1500/m²

E: 1500/m² or more

### (6-2) Hue

Hue of an end face of a monolayer film roll obtained was evaluated in accordance with the criteria below.
A: Yellowing was not observed.
B: Slight yellowing was observed.
C: Significant yellowing was observed.

### Example 1

After 100 parts by mass of EVOH c1-1 pellets and 0.1 parts by mass of glycerin monostearate were dry-blended, the blend was melt-kneaded under the following conditions to prepare EVOH resin composition pellets. <Conditions of pellet preparation>

Apparatus: 30 mmcp twin screw extruder from Toyo Seiki Seisaku-sho, to Ltd.
L/D: 45.5
Screw: equi-directional complete meshing type
Extrusion temperature (° C.): 230° C.
Rotation speed: 200 rpm
Discharge rate: 20 kg/hr

Using the EVOH resin composition pellets obtained as an EVOH resin composition layer (C), mLLDPE1 as an PO layer (A), and MAH-PE1 as an adhesive resin layer (B), a multilayer film was prepared under the following conditions by a co-extrusion multilayered cast film forming apparatus. When the multilayer film is formed, resin pressure stability was evaluated as described in aforementioned Evaluation method (2). The results are shown in Table 1.

### <Conditions of Preparation of a Multilayer Film>

Layer configuration: ((A)/(B)/(C)/(B)/(A)=42.5 μm/5 μm/5 μm/5 μm/42.5 μm)
T die: for 300 mm-width three-material five-layer (Research Laboratory of Plastics Technology Co., Ltd.)
Cooling roll temperature: 80° C.
Take-up speed: 1.5 m/min
   (Polyolefin layer (A))
Extruder: 32 mmcp extruder type GT-32-A (Research Laboratory of Plastics Technology Co., Ltd.)
Temperature conditions: supply section/compression section/metering section/die=170/220/220/220° C. to (Adhesive resin layer (B))
Extruder: 25 mmcp extruder type P25-18-AC (Osaka Seiki Kosaku)
Temperature conditions: supply section/compression section/metering section/die=170/220/220/220° C.
   (EVOH resin composition layer (C))
Extruder: 20 mmcp extruder laboratory machine ME type CO-EXT (Toyo Seiki Seisaku-sho, Ltd.)
Temperature conditions: supply section/compression section/metering section/die=170/220/220/220° C.

### Examples 2 to 5, Examples 12 to 22, Comparative Examples 1 to 5, and Comparative Examples 12 to 15

EVOH resin composition pellets and a multilayer film were produced and evaluated as described in Example 1, except that the type and a content of an EVOH resin (c1), the type and a content of a hydrophobic plasticizer (c2), and a thickness ratio of an EVOH resin composition layer (C) and a PO layer (A) were changed as described in Tables 1 and 2. The results are shown in Tables 1 and 2.

### Example 6

EVOH resin composition pellets and a multilayer film were produced and evaluated as described in Example 1, except that 80 parts by mass of EVOH c1-1 pellets, 20 parts by mass of thermoplastic resin c4-1 pellets, and 1 part by mass of glycerin monostearate were dry-blended. The results are shown in Table 1.

### Example 7, Example 11, Comparative Examples 6 to 8, and Comparative Example 11

EVOH resin composition pellets and a multilayer film were produced and evaluated as described in Example 6, except that a content of an EVOH resin (c1), the type and a content of a thermoplastic resin (c4), and a content of a hydrophobic plasticizer (c2) are changed as shown in Tables 1 and 2. The results are shown in Tables 1 and 2.

### Example 8

EVOH resin composition pellets and a multilayer film were produced and evaluated as described in Example 1, except that 80 parts by mass of EVOH c1-1 pellets, 16 parts by mass of thermoplastic resin c4-3 pellets, 4 parts by mass of thermoplastic resin c4-4 pellets and 1 part by mass of glycerin monostearate were dry-blended. The results are shown in Table 1.

(Examples 9, 10, and Comparative Examples 9, 10)

EVOH resin composition pellets and a multilayer film were produced and evaluated as described in Example 8, except that a content of an EVOH resin (c1), the type, a mass ratio and a content of a thermoplastic resin (c4), and a content of a hydrophobic plasticizer (c2) are changed. The results are shown in Tables 1 and 2.

TABLE 1

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 | ple 11 |
| Layer | EVOH resin | Type | c1-1 | c1-1 | c1-1 | c1-1 | c1-2 | c1-1 | c1-1 | c1-1 | c1-1 | c1-1 | c1-1 |
| (C) | (c1) | Ethylene-unit | 48 | 48 | 48 | 48 | 38 | 48 | 48 | 48 | 48 | 48 | 48 |
| | | content | | | | | | | | | | | |
| | | [mol %] | | | | | | | | | | | |
| | | Content | 100 | 100 | 100 | 100 | 100 | 80 | 80 | 80 | 70 | 75 | 80 |
| | | [parts by mass] | | | | | | | | | | | |
| | | Type | — | — | — | — | — | — | — | — | — | — | — |
| | | Ethylene-unit | — | — | — | — | — | — | — | — | — | — | — |
| | | content | | | | | | | | | | | |
| | | [mol %] | | | | | | | | | | | |
| | | Content | — | — | — | — | — | — | — | — | — | — | — |
| | | [parts by mass] | | | | | | | | | | | |
| | | Ethylene-unit | 48 | 48 | 48 | 48 | 38 | 48 | 48 | 48 | 48 | 48 | 48 |
| | | content | | | | | | | | | | | |
| | | (Average, mol %) | | | | | | | | | | | |
| | Thermoplastic | Type | | | | | | c4-1 | c4-2 | c4-3/ | c4-3/ | c4-5/ | c4-6 |
| | resin | (Mass ratio) | | | | | | | | c4-4 | c4-4 | c4-4 | |
| | (c4) | | | | | | | | | (80/20) | (80/20) | (80/20) | |
| | | Content | 0 | 0 | 0 | 0 | 0 | 20 | 20 | 20 | 30 | 25 | 20 |
| | | [parts by mass] | | | | | | | | | | | |
| | Hydrophobic | Type | GMS | GMS | GMS | GMS | GMS | GMS | GMS | GMS | GMS | GMS | GMS |
| | plasticizer | Content | 0.1 | 0.6 | 1 | 3 | 1 | 1 | 1 | 1 | 1 | 1 | 1 |
| | (c2) | [Mass %] | | | | | | | | | | | |
| | Phosphoric | Type | 1) | 1) | 1) | 1) | 1) | 1) | 1) | 1) | 1) | 1) | 1) |
| | acid | Content | 50 | 50 | 50 | 50 | 50 | 40 | 40 | 40 | 35 | 38 | 40 |
| | compound | [ppm] | | | | | | | | | | | |
| | (c3) | | | | | | | | | | | | |
| | Thickness ratio [%] | | 5 | 5 | 5 | 5 | 5 | 5 | 5 | 5 | 5 | 5 | 5 |
| Layer | Polyolefin resin | | 2) | 2) | 2) | 2) | 2) | 2) | 2) | 2) | 2) | 2) | 2) |
| (A) | Thickness ratio [%] | | 85 | 85 | 85 | 85 | 85 | 85 | 85 | 85 | 85 | 85 | 85 |
| Layer | Adhesive resin | | 3) | 3) | 3) | 3) | 3) | 3) | 3) | 3) | 3) | 3) | 3) |
| (B) | Thickness ratio [%] | | 10 | 10 | 10 | 10 | 10 | 10 | 10 | 10 | 10 | 10 | 10 |
| Evalu- | Layer (C) | Resin pressure | A | A | A | A | A | A | A | A | A | A | A |
| ation | | stability | | | | | | | | | | | |
| | Multilayer | Appearance | A | A | A | A | A | A | A | A | A | A | A |
| | film | Bending | B | B | B | B | B | A | A | A | A | A | A |
| | | resistance | | | | | | | | | | | |
| | Recovered | Fisheyes | B | B | B | B | B | B | B | A | A | A | A |
| | composition | Hue | A | A | A | A | A | B | B | A | A | A | A |
| | | | Exam- | Exam- | Exam- | Exam- | Exam- | Exam- | Exam- | Exam- | Exam- | Exam- | Exam- |
| | | | ple 12 | ple 13 | ple 14 | ple 15 | ple 16 | ple 17 | ple 18 | ple 19 | ple 20 | ple 21 | ple 22 |
| Layer | EVOH resin | Type | c1-1 | c1-1 | c1-1 | c1-1 | c1-1 | c1-1 | c1-1 | c1-3 | c1-4 | c1-5 | c1-6 |
| (C) | (c1) | Ethylene-unit | 48 | 48 | 48 | 48 | 48 | 48 | 48 | 48 | 48 | 48 | 27 |
| | | content | | | | | | | | | | | |
| | | [mol %] | | | | | | | | | | | |
| | | Content | 100 | 100 | 100 | 100 | 100 | 100 | 100 | 100 | 100 | 100 | 80 |
| | | [parts by mass] | | | | | | | | | | | |
| | | Type | — | — | — | — | — | — | — | — | — | — | c1-7 |
| | | Ethylene-unit | — | — | — | — | — | — | — | — | — | — | 44 |
| | | content | | | | | | | | | | | |
| | | [mol %] | | | | | | | | | | | |
| | | Content | — | — | — | — | — | — | — | — | — | — | 20 |
| | | [parts by mass] | | | | | | | | | | | |
| | | Ethylene-unit | 48 | 48 | 48 | 48 | 48 | 48 | 48 | 48 | 48 | 48 | 30 |
| | | content | | | | | | | | | | | |
| | | (Average, mol %) | | | | | | | | | | | |
| | Thermoplastic | Type | | | | | | | | | | | |
| | resin | (Mass ratio) | | | | | | | | | | | |
| | (c4) | Content | 0 | 0 | 0 | 0 | 0 | 0 | 0 | 0 | 0 | 0 | 0 |
| | | [parts by mass] | | | | | | | | | | | |
| | Hydrophobic | Type | GML | DEP | DEP | DGL | TGML | GTS | GMS | GMS | GMS | GMS | GMS |
| | plasticizer | Content | 1 | 0.1 | 1 | 1 | 1 | 1 | 1 | 1 | 1 | 1 | 1 |
| | (c2) | [Mass %] | | | | | | | | | | | |
| | Phosphoric | Type | 1) | 1) | 1) | 1) | 1) | 1) | 1) | 1) | 1) | — | 1) |
| | acid | Content | 50 | 50 | 50 | 50 | 50 | 50 | 50 | 25 | 300 | 0 | 50 |
| | compound | [ppm] | | | | | | | | | | | |
| | (c3) | | | | | | | | | | | | |
| | Thickness ratio [%] | | 5 | 5 | 5 | 5 | 5 | 5 | 6.5 | 5 | 5 | 5 | 5 |
| Layer | Polyolefin resin | | 2) | 2) | 2) | 2) | 2) | 2) | 2) | 2) | 2) | 2) | 2) |
| (A) | Thickness ratio [%] | | 85 | 85 | 85 | 85 | 85 | 85 | 84 | 85 | 85 | 85 | 85 |
| Layer | Adhesive resin | | 3) | 3) | 3) | 3) | 3) | 3) | 3) | 3) | 3) | 3) | 3) |
| (B) | Thickness ratio [%] | | 10 | 10 | 10 | 10 | 10 | 10 | 10 | 10 | 10 | 10 | 10 |
| Evalu- | Layer (C) | Resin pressure | A | A | A | A | A | A | A | A | A | A | A |
| ation | | stability | | | | | | | | | | | |
| | Multilayer | Appearance | A | B | B | A | A | A | A | A | A | A | A |
| | film | Bending | B | B | B | B | B | B | B | B | B | B | B |
| | | resistance | | | | | | | | | | | |
| | Recovered | Fisheyes | B | B | B | B | B | B | C | B | B | A | B |
| | composition | Hue | A | A | A | A | A | A | A | A | A | C | A |

1) Sodium dihydrogen phosphate,
2) mLLDPE,
3) MAH-PE

TABLE 2

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | | | Example 1 | Example 2 | Example 3 | Example 4 | Example 5 | Example 6 | Example 7 | Example 8 |
| Layer | EVOH resin | Type | c1-1 | c1-8 | c1-1 | c1-1 | c1-1 | c1-1 | c1-1 | c1-1 |
| (C) | (c1) | Ethylene-unit | 48 | 29 | 48 | 48 | 48 | 48 | 48 | 48 |
| | | content | | | | | | | | |
| | | [mol %] | | | | | | | | |
| | | Content | 100 | 100 | 100 | 100 | 100 | 80 | 70 | 50 |
| | | [parts by mass] | | | | | | | | |
| | | Ethylene-unit | 48 | 29 | 48 | 48 | 48 | 48 | 48 | 48 |
| | | content | | | | | | | | |
| | | (Average, mol %) | | | | | | | | |
| | Thermoplastic | Type | | | | | | c4-7 | c4-1 | c4-1 |
| | resin | (Mass ratio) | | | | | | | | |
| | (c4) | Content | 0 | 0 | 0 | 0 | 0 | 20 | 30 | 50 |
| | | [parts by mass] | | | | | | | | |
| | Hydrophobic | Type | — | GMS | GMS | GMS | GLR¹⁾ | GMS | — | GMS |
| | plasticizer | Content | 0 | 1 | 4 | 10 | 1 | 1 | 0 | 1 |
| | (c2) | [Mass %] | | | | | | | | |
| | Phosphoric | Type | 2) | 2) | 2) | 2) | 2) | 2) | 2) | 2) |
| | acid | Content | 50 | 50 | 50 | 50 | 50 | 40 | 35 | 25 |
| | compound | [ppm] | | | | | | | | |
| | (c3) | | | | | | | | | |
| | Thickness ratio [%] | | 5 | 5 | 5 | 5 | 5 | 5 | 5 | 5 |
| Layer | Polyolefin resin | | 3) | 3) | 3) | 3) | 3) | 3) | 3) | 3) |
| (A) | Thickness ratio [%] | | 85 | 85 | 85 | 85 | 85 | 85 | 85 | 85 |
| Layer | Adhesive resin | | 4) | 4) | 4) | 4) | 4) | 4) | 4) | 4) |
| (B) | Thickness ratio [%] | | 10 | 10 | 10 | 10 | 10 | 10 | 10 | 10 |
| Evaluation | Layer (C) | Resin pressure | A | A | C | D | C | A | A | A |
| | | stability | | | | | | | | |
| | Multilayer | Appearance | C | A | A | A | A | A | C | A |
| | film | Bending resistance | B | B | B | B | B | A | A | A |
| | Recovered | Fisheyes | B | D | B | B | B | E | C | D |
| | composition | Hue | A | A | A | A | A | C | B | B |

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | | | Example 9 | Example 10 | Example 11 | Example 12 | Example 13 | Example 14 | Example 15 |
| Layer | EVOH resin | Type | c1-1 | c1-1 | c1-1 | c1-1 | c1-1 | c1-1 | c1-9 |
| (C) | (c1) | Ethylene-unit | 48 | 48 | 48 | 48 | 48 | 48 | 48 |
| | | content | | | | | | | |
| | | [mol %] | | | | | | | |
| | | Content | 80 | 50 | 80 | 100 | 100 | 100 | 100 |
| | | [parts by mass] | | | | | | | |
| | | Ethylene-unit | 48 | 48 | 48 | 48 | 48 | 48 | 48 |
| | | content | | | | | | | |
| | | (Average, mol %) | | | | | | | |
| | Thermoplastic | Type | c4-3/c4-4 | c4-3/c4-4 | c4-6 | | | | |
| | resin | (Mass ratio) | (80/20) | (80/20) | | | | | |
| | (c4) | Content | 20 | 50 | 20 | 0 | 0 | 0 | 0 |
| | | [parts by mass] | | | | | | | |
| | Hydrophobic | Type | — | GMS | — | GMS | — | — | GMS |
| | plasticizer | Content | 0 | 1 | 0 | 1 | 0 | 0 | 1 |
| | (c2) | [Mass %] | | | | | | | |
| | Phosphoric | Type | 2) | 2) | 2) | 2) | 2) | 2) | 2) |
| | acid | Content | 40 | 25 | 50 | 50 | 50 | 50 | 600 |
| | compound | [ppm] | | | | | | | |
| | (c3) | | | | | | | | |
| | Thickness ratio [%] | | 5 | 5 | 5 | 10 | 10 | 7.7 | 5 |
| Layer | Polyolefin resin | | 3) | 3) | 3) | 3) | 3) | 3) | 3) |
| (A) | Thickness ratio [%] | | 85 | 85 | 85 | 80 | 80 | 82.3 | 85 |
| Layer | Adhesive resin | | 4) | 4) | 4) | 4) | 4) | 4) | 4) |
| (B) | Thickness ratio [%] | | 10 | 10 | 10 | 10 | 10 | 10 | 10 |
| Evaluation | Layer (C) | Resin pressure | A | A | A | A | A | A | A |
| | | stability | | | | | | | |
| | Multilayer | Appearance | C | D | C | A | A | B | B |
| | film | Bending resistance | A | A | A | C | C | C | B |
| | Recovered | Fisheyes | A | A | A | D | D | C | D |
| | composition | Hue | A | A | A | A | A | A | A |

¹⁾Hydrophilic plasticizer,
2) Sodium dihydrogen phosphate,
3) mLLDPE,
4) MAH-PE

Comparison between Examples 1 to 4 and Comparative Example 1 shows that appearance of the multilayer film is improved by adding the hydrophobic plasticizer (c2). Furthermore, comparison of Example 3 and Comparative Example 2 shows that recyclability is deteriorated when an average of ethylene-unit content is less than 30 mol %, while recyclability is satisfactory when an average of ethylene-unit content is more than 30 mol %. Comparison between Example 4 and Comparative Examples 3 to 4 shows that when a hydrophobic plasticizer is excessively added, a resin pressure of the EVOH resin composition layer (C) is unstable. Comparison between Example 3 and Comparative Example 5 shows that when a hydrophilic plasticizer is used, a resin pressure of the EVOH resin composition layer (C) is unstable.

Comparison between Example 3 and Examples 6 to 7 shows that bending resistance of the multilayer film is improved by adding Nylon 6/12 and Nylon 6/6/12 to the EVOH resin composition layer (C). Comparison between Examples 6 to 7 and Comparative Example 6 shows that addition of Nylon 6 to the EVOH resin composition layer (C) adversely affects recyclability of the multilayer film. Comparison between Example 6 and Comparative Example 8 shows that addition of an excessive amount of Nylon 6/12 to the EVOH resin composition layer (C) adversely affects recyclability of the multilayer film. Comparison between Example 3 and Examples 8 to 11 shows that when an unmodified polyolefin resin and an acid-modified polyolefin resin, or an EVOH with an ethylene content of more than 60 mol % are added to the EVOH resin composition layer (C), the multilayer film is improved not only in bending resistance, but also in recyclability.

Comparison between Example 9 and Comparative Example 10 shows that addition of an excessive amount of an unmodified polyolefin resin and an acid-modified polyolefin resin to the EVOH resin composition layer (C) causes appearance defect (turbidity) of the multilayer film. Comparison between Examples 3 and 18 and Comparative Example 12 shows that when a thickness ratio of the EVOH resin composition layer (C) in the multilayer film is more than 7.5%, bending resistance and recyclability of the multilayer film are deteriorated and thus it is more preferably 5% or less. From Comparative Example 12,

Comparative Example 13 and Comparative Example 14, it is shown that when a thickness ratio of the EVOH resin composition layer (C) in the multilayer film is more than 7.5%, good appearance is attained regardless of addition of a hydrophobic plasticizer (c2). Furthermore, given the results of Example 1 and Comparative Example 1, a thickness ratio of the EVOH resin composition layer

(C) in the multilayer film must be 7.5% or less for achieving good bending resistance and recyclability of the multilayer film, and it can be said that only when the above thickness ratio is 7.5% or less, addition of the hydrophobic plasticizer (c2) is effective.

Comparison between Example 3 and Comparative Example 15 shows that when a content of a phosphoric acid compound (c3) in the EVOH resin composition layer (C) is more than 500 ppm, recyclability (fisheyes) of the multilayer film is deteriorated. Comparison between Example 3 and Example 21 shows that addition of a phosphoric acid compound (c3) to the EVOH resin composition layer (C) is preferable in the light of hue of a recovered composition. Comparison between Example 1 and Example 13, and comparison between Example 3 and Example 14 show that as a hydrophobic plasticizer, an aliphatic ester preferably improves appearance more effectively than an aromatic ester. Comparison between Example 22 and Comparative Example 2 shows that with an average of ethylene-unit content of an EVOH resin (c1) being 30 mol % or more, recyclability is satisfactory.

### Example 23

A multilayer film was produced and evaluated as described in Example 3, except that, in place of EVOH resin composition pellets, a dry blend prepared by dry-blending100 parts by mass of EVOH c1-1 pellets and 1 part by mass of glycerin monostearate was used as a starting material for an EVOH resin composition layer (C). The results are shown in Table 3.

### (Evaluation of Adhesion Strength)

Adhesion strength between the EVOH resin composition layer (C) and the adhesive resin layer (B) in the multilayer films obtained in Example 3, Example 23 and Comparative Example 1 was measured under the conditions below. The multilayer film obtained in Example 3, Example 23 and

Comparative Example 1 was moisture-conditioned under an atmosphere of 23° C. and 50% RH for 7 days, and then cut into a 15 mm×200 mm strip-shaped test piece. The test piece was subjected to measurement for T-type peel strength (gf/15 mm) under the conditions of chuck distance=50 mm and take-off speed=250 mm/min by “Autograph Type AGS-H” from Shimadzu Corporation. The measurement was conducted for five test pieces, and an average of these was determined as adhesion strength. The results are shown in Table 3.

TABLE 3

| | | | | | Comparative |
|---|---|---|---|---|---|
| | | | Example 3 | Example 23 | Example 1 |
| Layer (C) | EVOH resin | Type | c1-1 | c1-1 | c1-1 |
| | (c1) | Ethylene-unit content | 48 | 48 | 48 |
| | | [mol %] | | | |
| | | Content [parts by mass] | 100 | 100 | 100 |
| | | Ethylene-unit content | 48 | 48 | 48 |
| | | (Average, mol %) | | | |
| | Hydrophobic | Type | GMS | GMS | — |
| | plasticizer (c2) | Content [Mass %] | 1 | 1 | 0 |
| | | Addition method¹⁾ | MB | DB | MB |
| | Phosphoric acid | Type | 3) | 3) | 3) |
| | compound (c3) | Content [ppm] | 50 | 50 | 50 |
| | Thickness ratio [%] | | 5 | 5 | 5 |
| Layer (A) | Polyolefin resin | | mLLDPE | mLLDPE | mLLDPE |
| | Thickness ratio [%] | | 85 | 85 | 85 |
| Layer (B) | Adhesive resin | | 4) | 4) | 4) |
| | Thickness ratio [%] | | 10 | 10 | 10 |
| Evaluation | Layer (C) | Resin pressure stability | A | A | A |
| | Multilayer | Appearance | A | A | C |
| | film | Bending resistance | B | B | B |
| | | Adhesion strength²⁾ | B | A | B |
| | Recovered | Fisheyes | B | B | B |
| | composition | Hue | A | A | A |

¹⁾MB: Melt blend, DB: Dry blend
²⁾A: 4N/15 mm or more, B: more than 2N/15 mm and less than 4N/15 mm, C: 2N/15 mm or less
3) Sodium dihydrogen phosphate
4) MAH-PE

The multilayer film of Example 3 prepared via EVOH resin composition pellets after melt-kneading had adhesion strength of 1.5N/15 mm while the multilayer film of Example 23 prepared using a dry blend as it was as a starting material for the EVOH resin composition layer (C) had adhesion strength of 4.6N/15 mm. It shows that adhesion strength is more improved for the multilayer film prepared using a dry blend as a starting material for the EVOH resin composition layer (C) than for the multilayer film prepared via an EVOH resin composition.

1. A multilayer film having a layer configuration in which a polyolefin layer (A), an adhesive resin layer (B) and an ethylene-vinyl alcohol copolymer resin composition layer (C) are laminated in this sequence, wherein
the ethylene-vinyl alcohol copolymer resin composition layer (C) comprises an ethylene-vinyl alcohol copolymer resin (c1) with an ethylene-unit content of 20 mol % or more and 60 mol % or less and a saponification degree of 90 mol % or more, and a hydrophobic plasticizer (c2);
a content of the ethylene-vinyl alcohol copolymer resin (c1) in the ethylene-vinyl alcohol copolymer resin composition layer (C) is 60% by mass or more and 99.9% by mass or less;
an average ethylene-unit content of the ethylene-vinyl alcohol copolymer resin (c1) constituting the ethylene-vinyl alcohol copolymer resin composition layer (C) is 30 mol % or more and mol % or less;
a content of the hydrophobic plasticizer (c2) in the ethylene-vinyl alcohol copolymer resin composition layer (C) is 0.1% by mass or more and 3% by mass or less;
the ethylene-vinyl alcohol copolymer resin composition layer (C) can further comprise a phosphoric acid compound (c3) and a content of the phosphoric acid compound (c3), when being comprised in the ethylene-vinyl alcohol copolymer resin composition layer (C), is 500 ppm or less in terms of phosphoric acid radical;
the ethylene-vinyl alcohol copolymer resin composition layer (C) is free from Nylon 6; and
a ratio of a thickness of the ethylene-vinyl alcohol copolymer resin composition layer (C) to the total thickness of the multilayer film is 7.5% or less.

2. The multilayer film according to claim 1, wherein the hydrophobic plasticizer (c2) comprised in the ethylene-vinyl alcohol copolymer resin composition layer (C) is an aliphatic ester.

3. The multilayer film according to claim 1, wherein a ratio of a thickness of the ethylene-vinyl alcohol copolymer resin composition layer (C) to the total thickness of the multilayer film is 5% or less.

4. The multilayer film according to claim 1 wherein a content of the hydrophobic plasticizer (c2) in the ethylene-vinyl alcohol copolymer resin composition layer (C) is 0.6% by mass or more and 3% by mass or less.

5. The multilayer film according to claim 1 wherein the ethylene-vinyl alcohol copolymer resin composition layer (C) comprises a thermoplastic resin (c4) other than the ethylene-vinyl alcohol copolymer resin (c1), and a mass ratio (c4/c1) of the thermoplastic resin (c4) to the ethylene-vinyl alcohol copolymer resin (c1) in the ethylene-vinyl alcohol copolymer resin composition layer (C) is 10/90 to 40/60.

6. The multilayer film according to claim 5, wherein the thermoplastic resin (c4) comprises an acid-modified polyolefin.

7. The multilayer film according to claim 5, wherein the thermoplastic resin (c4) comprises the ethylene-vinyl alcohol copolymer resin with an ethylene-unit content of more than 60 mol %.

8. The multilayer film according to claim 5, wherein the thermoplastic resin (c4) comprises at least one selected from the group consisting of Nylon 6/12, Nylon 6/66 and Nylon 6/66/12.

9. The multilayer film according to claim 1, wherein the polyolefin resin constituting the polyolefin layer (A) is at least one selected from the group consisting of a low density polyethylene, a medium density polyethylene, a high density polyethylene, a linear low density polyethylene and a polypropylene.

10. The multilayer film according to claim 1, wherein the polyolefin resin constituting the polyolefin layer (A) is a metallocene polyolefin produced by polymerization using a metallocene catalyst.

11. A food packaging material, a beverage packaging material, a medicine packaging material, a cosmetic packaging material, or an agricultural material produced using the multilayer film according to claim 1.

12. A recovered composition comprising a recovered material of the multilayer film according to claim 1.

13. A method for producing a recovered composition, comprising melt kneading a recovered material of the multilayer film according to claim 1.
